(19) United States
(12) Patent Application Publication
(10) Pub. No.: US 2010/0054418 A1
(43) Pub. Date: Mar. 4, 2010

(54) X-RAY DETECTING ELEMENT

(75) Inventors: Yoshihiro OKADA, Kanagawa (JP); Fumito NARIYUKI, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/547,511

(22) Filed: Aug. 26, 2009

(30) Foreign Application Priority Data
Aug. 29, 2008 (JP) 2008-221548

(51) Int. Cl. H05G 1/56

(52) U.S. Cl. 378/114

(57) ABSTRACT

The present invention provides an X-ray detecting element that can obtain radiation images by X-rays of different energies by irradiation of X-rays a single time, without positional offset arising. A first scintillator is provided at an outer side of a sensor portion and a sensor portion of one surface side of a substrate. A second scintillator is provided at another surface side of the substrate. X-rays that are irradiated from the one surface side or the other surface side of the substrate are converted into light at the first and second scintillators. The sensor portion detects light that is illuminated from the first scintillator of the one surface side, and the sensor portion detects light that is illuminated from the second scintillator of the other surface side of the substrate.

### CROSS-REFERENCE TO RELATED APPLICATION

This application claims priority under 35 USC 119 from Japanese Patent Application No. 2008-221548 filed on Aug. 29, 2008, the disclosure of which is incorporated by reference herein.

### BACKGROUND OF THE INVENTION

1. Field of the Invention

The present invention relates to an X-ray detecting element. In particular, the present invention relates to an X-ray detecting element that detects an image expressed by irradiated X-rays.

2. Description of the Related Art

X-ray detecting elements such as FPDs (flat panel detectors), in which an X-ray sensitive layer is disposed on a TFT (thin film transistor) active matrix substrate and that can convert X-ray information directly into digital data, and the like have been put into practice in recent years. As compared with a conventional imaging plate, an image can be confirmed immediately at an X-ray detecting element. Further, the FPD has the advantage that video images as well can be confirmed. Therefore, the popularization of FPDs has advanced rapidly.

Various types of X-ray detecting elements have been proposed. For example, there is a direct-conversion-type X-ray detecting element that converts X-rays directly into charges at a semiconductor layer, and accumulates the charges. Moreover, there is an indirect-conversion-type X-ray detecting element that once converts X-rays into light at a scintillator (a wavelength converting portion) of CsI:Tl, GOS (Gd2O2S:Tb), or the like, and, at sensor portions such as photodiodes or the like, converts the converted light into charges, and accumulates the charges.

The following technique is known in the photographing of radiation images. By photographing the same region of a subject at different tube voltages, and carrying out image processing (hereinafter called “subtraction image processing”) that weights the radiation images obtained by the photographings at the respective tube voltages and computes the difference therebetween, a radiation image (hereinafter called “energy subtraction image”) is obtained in which one of an image portion, that corresponds to hard tissue such as bones or the like within the image, and an image portion, that corresponds to soft tissue, is emphasized and the other is removed. For example, when using an energy subtraction image that corresponds to soft tissue of the chest region, pathological changes that are hidden by the ribs can be seen. Accordingly, this technique can improve diagnostic performance.

In the case when obtaining an energy subtraction image with an analog X-ray film or an imaging plate, X-rays are irradiated a single time while two X-ray films or imaging plates are superposed one on the other, and the energy subtraction image can be obtained by carrying out subtraction image processing on the two radiation images that are obtained from the respective X-ray films or imaging plates.

On the other hand, with an X-ray detecting element, there is proposed a method of photographing that, when an energy subtraction image is to be obtained, X-rays of different energies are irradiated two times in succession with respect to a single X-ray detecting element, and two radiation images are obtained. Further, with an X-ray detecting element, there is proposed a method in which two radiation images are obtained by irradiating X-rays one time with two X-ray detecting elements superposed one on the other, similarly to the case of X-ray films or imaging plates.

In the former photographing method, the irradiation of X-rays is carried out twice. The amount of radiation to which the subject is exposed thereby increases. Further, in the former photographing method, the images become offset between the two times irradiation is carried out.

In the latter photographing method, image quality deteriorates due to offset between the two X-ray detecting elements that is caused by dimensional errors from the time of manufacturing the X-ray detecting elements, or by vibration or expansion. Further, in this latter photographing method, because the X-rays are irradiated radially from the X-ray source, if two of the X-ray detecting elements are superposed one on the other, the image sizes of the radiation images that are obtained from the respective X-ray detecting elements differ. Still further, costs in the latter photographing method are higher than in a case of using a single X-ray detecting element.

Japanese Patent Application Laid-Open (JP-A) No. 2000-298198 discloses a technique of obtaining an energy subtraction image by layering plural individual radiation detecting layers and carrying out subtraction image processing on the radiation images obtained from the respective individual radiation detecting layers. In this case, correction of the pixel size is carried out so that the pixel sizes of the respective radiation images become the same.

However, in a case of obtaining radiation images by X-rays of different energies by the irradiation of X-rays a single time, it is preferable that there be no positional offset among the respective radiation images.

### SUMMARY OF THE INVENTION

The present invention provides an X-ray detecting element that can obtain radiation images by X-rays of different energies by the irradiation of X-rays a single time, without positional offset arising.

A first aspect of the present invention is an X-ray detecting element including: a substrate that is light-transmissive; a first photodiode provided at one surface side of the substrate, detecting light that is illuminated from the one surface side, and generating charges; a second photodiode provided at the one surface side of the substrate, detecting light that is illuminated from another surface side of the substrate, and generating charges; a plurality of wavelength converting portions respectively provided at outer sides of the first photodiode and the second photodiode of the one surface side of the substrate, and at the another surface side of the substrate, and generating light when X-rays are irradiated; a first switching element, provided at the one surface side of the substrate and connected to the first photodiode, for reading-out charges that are generated at the first photodiode; and a second switching element, provided at the one surface side of the substrate and connected to the second photodiode, for reading-out charges that are generated at the second photodiode.

At the X-ray detecting element of the present invention, the first photodiode, that detects light and generates charges, is provided at the one surface side of the substrate that is light-transmissive. The first photodiode detects light, that is illuminated from the one surface side, and generates charges. Further, at the X-ray detecting element of the present invention, the second photodiode, that detects light and generates charges, is provided at the one surface side of the substrate. The second photodiode detects light, that is illuminated from the other surface side of the substrate, and generates charges. Further, at the X-ray detecting element of the present invention, the wavelength converting portions, that generate light when X-rays are irradiated, are provided respectively at the outer side of the first photodiode and the second photodiode of the one surface side of the substrate, and at the other surface side of the substrate. The wavelength converting portions generate light when X-rays are irradiated.

Moreover, in the present invention, the first switching element and the second switching element are provided on the one surface of the substrate. The first switching element is connected to the first X-ray detecting section, and is for reading-out the charges generated at the first X-ray detecting section. The second switching element is connected to the second X-ray detecting section, and is for reading-out the charges generated at the second X-ray detecting section.

In this way, in accordance with the present invention, the wavelength converting portions are respectively provided at the outer side of the first photodiode and the second photodiode of the one surface side of the substrate, and at the other surface side of the substrate. Further, the wavelength converting portions convert X-rays, that are irradiated from the one surface side or the other surface side of the substrate, into light. The first photodiode detects the light that is illuminated from the wavelength converting portion of the one surface side. The second photodiode detects the light that is illuminated from the wavelength converting portion of the other surface side of the substrate. Accordingly, radiation images by X-rays of different energies can be obtained by the irradiation of X-rays a single time, without positional offset arising.

In a second aspect of the present invention, in the above-described aspect, the first photodiode and the second photodiode may be layered.

In a third aspect of the present invention, in the above-described aspect, the first photodiode and the second photodiode may be aligned in the same layer, and the X-ray detecting element may further have: a first light-blocking film that blocks light at the another surface side of the first photodiode; and a second light-blocking film that blocks light at the one surface side of the second photodiode.

In a fourth aspect of the present invention, in the above-described aspect, irradiated sides of the wavelength converting portions, at which X-rays are irradiated, may have high sensitivity with respect to low energy X-rays, and non-irradiated sides of the wavelength converting portions may have high sensitivity with respect to high energy X-rays.

In a fifth aspect of the present invention, in the above-described aspect, the first switching element and the second switching element may be formed in the same layer.

In a sixth aspect of the present invention, in the above-described aspect, the first switching element, the second switching element, and at least one of the first photodiode or the second photodiode may be formed in the same layer.

In a seventh aspect of the present invention, in the above-described aspect, the first switching element and the second switching element may be thin-film transistors, and at least one of the first photodiode or the second photodiode may be an MIS photodiode, and a semiconductor layer of the MIS photodiode and semiconductor active layers of the thin-film transistors are formed in the same layer, and an insulating layer of the photodiode and insulating layers of the thin-film transistors may be formed in the same layer.

In an eighth aspect of the present invention, in the above-described aspect, X-rays may be irradiated from the one surface side of the substrate.

In a ninth aspect of the present invention, in the above-described aspect, a plurality of pixel portions, that detect X-rays as information of pixels structuring a radiation image, may be provided at the substrate in a surface direction, and a plurality of the first photodiode, the second photodiode, the first switching element, and the second switching element may be respectively provided for each of the pixel portions.

The X-ray detecting element of the present invention can obtain radiation images by X-rays of different energies by the irradiation of X-rays a single time, without positional offset arising.

### BRIEF DESCRIPTION OF THE DRAWINGS

Exemplary embodiments of the present invention will be described in detail based on the following figures, wherein:

FIG. 1 is a structural drawing showing the overall structure of a radiation image photographing device relating to the exemplary embodiments;

FIG. 2 is a schematic drawing showing the schematic structure of one pixel of an X-ray detecting element relating to a first exemplary embodiment;

FIG. 3 is a plan view showing the structure of the X-ray detecting element relating to the first exemplary embodiment;

FIG. 4 is a cross-sectional view of the X-ray detecting element relating to the first exemplary embodiment;

FIG. 5 is a schematic drawing showing the flow of X-rays that are incident on one pixel of the X-ray detecting element relating to the first exemplary embodiment;

FIG. 6 is a cross-sectional view of an X-ray detecting element relating to a second exemplary embodiment; and

FIG. 7 is a plan view showing the structure of the X-ray detecting element relating to the second exemplary embodiment.

### DETAILED DESCRIPTION OF THE INVENTION

A radiation image photographing device 100, to which exemplary embodiments of an image detector of the present invention are applied, will be described hereinafter with reference to the drawings.

### First Exemplary Embodiment

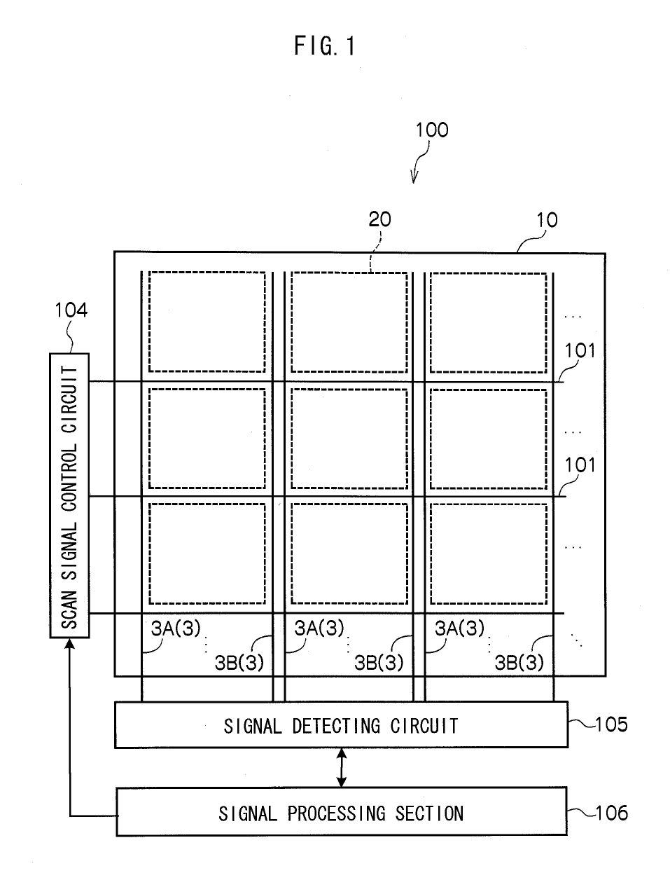

The schematic structure of the radiation image photographing device 100 relating to the present exemplary embodiment is shown in FIG. 1.

As shown in FIG. 1, the radiation image photographing device 100 relating to the present exemplary embodiment has an X-ray detecting element 10.

As shown in FIG. 1, at the X-ray detecting element 10, plural pixels 20 are provided in the form of a matrix in one direction (the horizontal direction in FIG. 1) and in a direction (the vertical direction in FIG. 1) intersecting the one direction.

Scan lines 101 are provided in parallel at the X-ray detecting element 10, with each of the scan lines 101 corresponding to a row of pixels in the one direction. Further, signal lines 3 are provided in parallel at the X-ray detecting element 10, with the signal lines 3 corresponding to columns of pixels in the intersecting direction. Note that, at the X-ray detecting element 10 relating to the present exemplary embodiment, two of the signal lines 3 are provided for each of the pixel columns in the intersecting direction. Namely, a signal line 3A is provided at one side (the left side in FIG. 1) of the pixels 20 in a pixel column, and a signal line 3B is provided at the other side (the right side in FIG. 1) of the pixels 20.

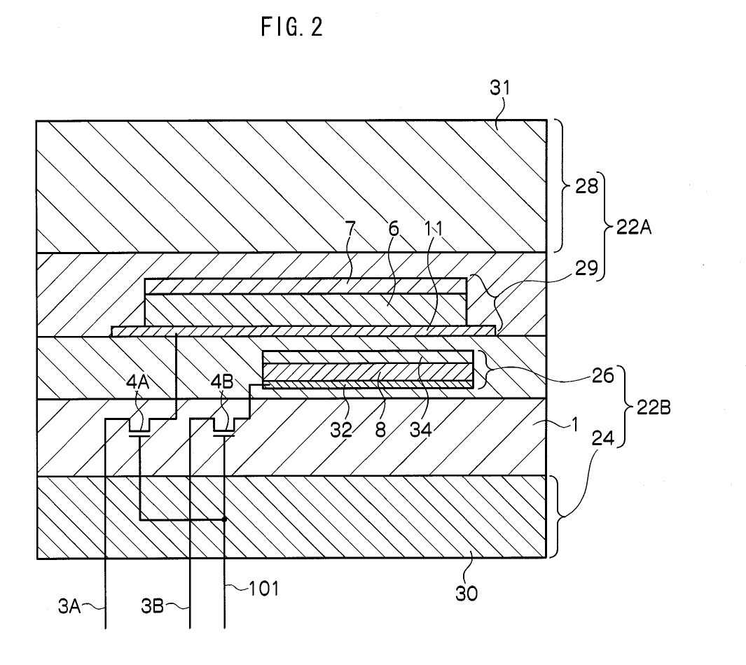

A schematic drawing illustrating the schematic structure of one of the pixels 20 of the X-ray detecting element 10 relating to the first exemplary embodiment is shown in FIG. 2.

As shown in FIG. 2, two X-ray detecting sections 22A, 22B, those are sensitive to X-rays and detect X-rays and generate charges, are provided so as to be layered at the pixel 20.

The X-ray detecting section 22A and the X-ray detecting section 22B are indirect-conversion-type detecting sections that convert X-rays into light once, and thereafter, convert the light into charges and accumulate the charges. The X-ray detecting section 22A has, at one surface (the upper side surface in FIG. 2) side of a substrate 1, a wavelength converting portion 28 that generates light when X-rays are irradiated. The X-ray detecting section 22A also has a sensor portion 29 that generates charges due to the light, that is generated at the wavelength converting portion 28, being illuminated. Further, the X-ray detecting section 22B has, at another surface (the lower side surface in FIG. 2) side of the substrate 1, a wavelength converting portion 24 that generates light when X-rays are irradiated. The X-ray detecting section 22B also has a sensor portion 26 that generates charges due to the light, that is generated at the wavelength converting portion 24, being illuminated.

A TFT switch 4A and a TFT switch 4B are provided at the pixel 20. The TFT switch 4A is connected to the X-ray detecting section 22A, and is for reading-out the charges that are generated at the X-ray detecting section 22A. The TFT switch 4B is connected to the X-ray detecting section 22B, and is for reading-out the charges that are generated at the X-ray detecting section 22B.

The source of the TFT switch 4A is connected to the X-ray detecting section 22A, the drain is connected to the signal line 3A, and the gate is connected to the scan line 101. The source of the TFT switch 4B is connected to the X-ray detecting section 22B, the drain is connected to the signal line 3B, and the gate is connected to the scan line 101.

Due to any of the TFT switches 4A that are connected to the signal line 3A being turned on, an electric signal corresponding to the charge amount that is generated and accumulated at the X-ray detecting section 22A flows to the signal line 3A. Further, due to any of the TFT switches 4B that are connected to the signal line 3B being turned on, an electric signal corresponding to the charge amount that is generated and accumulated at the X-ray detecting section 22B flows to the signal line 3B.

A signal detecting circuit 105 (see FIG. 1), that detects the electric signals that flow-out to the respective signal lines 3A, 3B, is connected to the signal lines 3A, 3B. A scan signal control circuit 104 is connected to the respective scan lines 101. The scan signal control circuit 104 outputs, to the scan lines 101, control signals for turning the TFT switches 4A, 4B ON and OFF.

An amplifying circuit that amplifies the inputted electric signal is incorporated in the signal detecting circuit 105 for each of the signal lines 3A, 3B. The signal detecting circuit 105 amplifies, at the respective amplifying circuits, the electric signals that are inputted from the respective signal lines 3A, 3B, and detects the signals. Due thereto, the signal detecting circuit 105 detects, as information of the respective pixels structuring the image, the charge amounts that are generated at the two X-ray detecting sections 22A, 22B of the respective pixels 20.

A signal processing device 106 is connected to the signal detecting circuit 105 and the scan signal control circuit 104. The signal processing device 106 divides the information of the respective pixels, that are detected at the signal detecting circuit 105, into image information from the signal lines 3A and image information from the signal lines 3B, and carries out predetermined processing thereon. Further, the signal processing device 106 outputs control signals that express signal detecting timings with respect to the signal detecting circuit 105. The signal processing device 106 also outputs control signals that express scan signal outputting timings, with respect to the scan signal control circuit 104. Note that, in the present exemplary embodiment, the respective signal lines 3A, 3B are connected to the one signal detecting circuit 105. However, two of the signal detecting circuits 105 may be provided, and the signal lines 3A and the signal lines 3B may be connected to the separate signal detecting circuits 105. In accordance with this structure, a signal detecting circuit, that is used in a conventional X-ray detecting element that detects one radiation image, can be utilized.

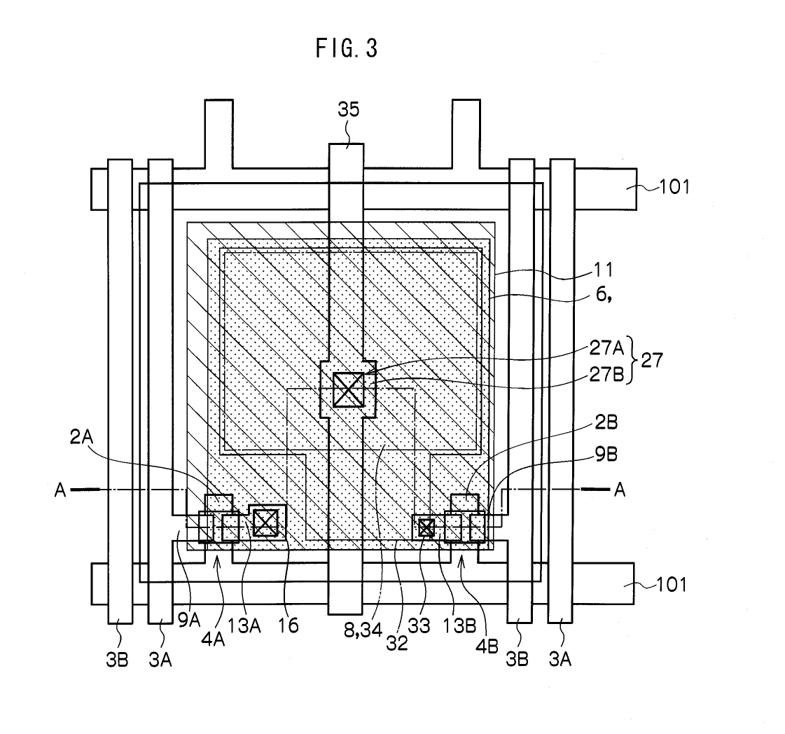

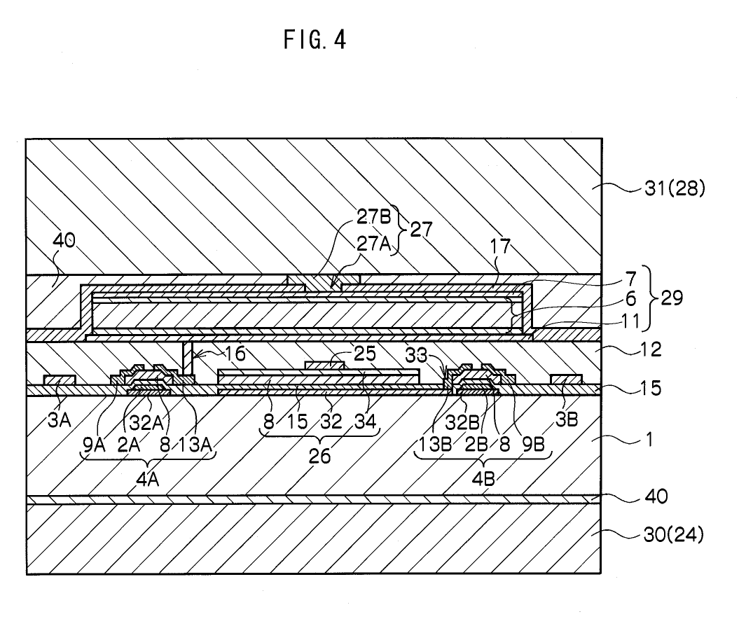

Next, the X-ray detecting element 10 relating to the first exemplary embodiment will be described in further detail with reference to FIG. 3 and FIG. 4. Note that a plan view showing the detailed structure of the pixel 20 of the X-ray detecting element 10 relating to the present exemplary embodiment is shown in FIG. 3. Further, a cross-sectional view along line A-A of FIG. 3 is shown in FIG. 4.

As shown in FIG. 4, at the X-ray detecting element 10, an electrode 32 is formed on one surface (the upper side surface in FIG. 4) of the insulating substrate 1 that is formed from alkaline-free glass or the like. The electrode 32 is formed from an amorphous transparent conductive oxide film (ITO), and is light-transmissive. Note that, in the present exemplary embodiment, electrodes 32A, 32B are formed from ITO also at gate electrode 2A, 2B regions that will be described later. However, this structure is not an essential structure.

The scan line 101 (see FIG. 3) and the two gate electrodes 2A, 2B are formed at the upper layer of the substrate 1 and the electrode 32. The gate electrodes 2A, 2B are respectively connected to the scan line 101. The wiring layer at which the scan line 101 and the gate electrodes 2A, 2B are formed (hereinafter, this wiring layer will also be called a “first signal wiring layer”), is formed by using Al or Cu, or a layered film formed mainly of Al or Cu. However, the material of the wiring layer is not limited to these.

An insulating film 15 is formed on the first signal wiring layer on the entire surface thereof. The regions of the insulating film 15, which regions are positioned on the gate electrodes 2A, 2B, act as gate insulating films at the TFT switches 4A, 4B. Further, the region of the insulating film 15, which region is positioned on the electrode 32, acts as an insulating layer at an MIS photodiode that will be described later. The insulating film 15 is formed from, for example, SiN_{X} or the like. The insulating film 15 is formed by, for example, CVD (Chemical Vapor Deposition). A contact hole 33 is formed in the insulating film 15 at the electrode 32 end portion.

A semiconductor layer 8 is formed on the insulating film 15 at positions corresponding to the gate electrodes 2A, 2B and at a position corresponding to the electrode 32. The regions of the semiconductor layer 8 that are positioned on the gate electrodes 2A, 2B act as semiconductor active layers (channel portions) at the TFT switches 4A, 4B. The region of the semiconductor layer 8 that is positioned on the electrode 32 acts as a semiconductor layer at the MIS photodiode that will be described later. The semiconductor layer 8 is formed from, for example, an amorphous silicon film.

Source electrodes 9A, 9B and drain electrodes 13A, 13B are formed on the above-described layers. The source electrodes 9A, 9B and the drain electrodes 13A, 13B, as well as the signal lines 3A, 3B, are formed at the wiring layer at which the source electrodes 9A, 9B and the drain electrodes 13A, 13B are formed (hereinafter, this wiring layer will also be called a “second signal wiring layer”). Further, in the second signal wiring layer, an electrode 34 is formed on the semiconductor layer 8. The source electrode 9A is connected to the signal line 3A (see FIG. 3). The source electrode 9B is connected to the signal line 3B. The drain electrode 13B is connected to the electrode 32 via the contact hole 33. The second signal wiring layer, in which the source electrodes 9A, 9B, the drain electrodes 13A, 13B, the electrode 34 and the signal wires 3A, 3B are formed, is formed by using Al or Cu, or a layered film formed mainly of Al or Cu. However, the material of the wiring layer is not limited to these.

A contact layer (not illustrated) is formed between, on the one hand, the source electrodes 9A, 9B, the drain electrodes 13A, 13B and the electrode 34, and, on the other hand, the semiconductor layer 8. The contact layer is formed from an impurity doped semiconductor such as an impurity doped amorphous silicon or the like.

At the X-ray detecting element 10 relating to the present exemplary embodiment, the TFT switch 4A is structured by the gate electrode 2A, the gate insulating film 15, the source electrode 9A, the drain electrode 13A and the semiconductor layer 8. Further, in the X-ray detecting element 10 relating to the present exemplary embodiment, the TFT switch 4B is structured by the gate electrode 2B, the gate insulating film 15, the source electrode 9B, the drain electrode 13B and the semiconductor layer 8. Note that, at the TFT switch 4A, the source electrode 9A and the drain electrode 13A are opposite due to the polarities of the charges generated at the X-ray detecting section 22A. Further, at the TFT switch 4B, the source electrode 9B and the drain electrode 13B are opposite due to the polarities of the charges generated at the X-ray detecting section 22B.

At the X-ray detecting element 10 relating to the present exemplary embodiment, the MIS photodiode is structured by the electrode 32, the semiconductor layer 8, the insulating film 15 and the electrode 34. In the present exemplary embodiment, this photodiode corresponds to the sensor portion 26.

A common electrode line 25 is formed parallel to the signal lines 3A, 3B on the first signal wiring layer, at the central portion of the pixel 20. The common electrode line 25 is connected to the electrode 34. The common electrode line 25 is connected to a bias power source (not shown), and bias voltage of around from several V to several tens of V is supplied thereto from the bias power source. Note that, in FIG. 3, the common electrode line 25 is not illustrated because a common electrode line 35, that will be described later, is superposed therewith.

An interlayer insulating film 12 is formed on substantially the entire surface of the region on the substrate 1 where the pixel 20 is provided (substantially the entire region). The interlayer insulating film 12 is formed from an organic material such as an acrylic resin or the like that is photosensitive. The film thickness of the interlayer insulating film 12 is 1 to 4 μm, and the dielectric constant thereof is 2 to 4. In the X-ray detecting element 10 relating to the present exemplary embodiment, the capacity between the metals that are disposed at the upper layer and the lower layer of the interlayer insulating film 12 is kept low by the interlayer insulating film 12. Further, generally, such a material also functions as a flattening (leveling) film. Accordingly, the interlayer insulating film 12 also has the effect of flattening the steps (number of stepped levels due to layered films) of the lower layer. Because the shape of a semiconductor layer 6 that is disposed at the upper layer is flattened by the interlayer insulating film 12, a decrease in the absorption efficiency due to unevenness of the semiconductor layer 6, and an increase in leak current can be suppressed. A contact hole 16 is formed in the interlayer insulating film 12 at a position opposing the drain electrode 13A.

At each of the pixels 20, a lower electrode 11 is formed on the interlayer insulating film 12 so as to cover the pixel region while filling-in the contact hole 16. The lower electrode 11 is formed from an amorphous transparent conductive oxide film (ITO). The lower electrode 11 is connected to the drain electrode 13A. In a case in which the semiconductor layer 6 that will be described later is thick at around 1 μm, there are hardly any limits on the material of the lower electrode 11 provided that it is conductive. Therefore, it suffices to form the lower electrode 11 by using a conductive metal such as an Al material, ITO (indium tin oxide) or the like.

On the other hand, it is preferable that the lower electrode be an alloy, or a layered film, formed mainly of a light-blocking metal. The lower electrode 11 thereby prevents incident light from below from interfering. Note that a light-blocking film may be formed by a light-blocking member between the semiconductor layer 6 and the semiconductor layer 8, for example, on the interlayer insulating film 12, for the purpose of preventing incidence of light. Or, the interlayer insulating film 12 itself may be made to be light-blocking.

The semiconductor layer 6 that functions as a photodiode is formed on the lower electrode 11. In the present exemplary embodiment, a photodiode of a PIN structure is employed as the semiconductor layer 6. Accordingly, the semiconductor layer 6 is formed by layering an n⁺ layer, an i layer and a p⁺ layer in that order from the lower layer. Note that, in the present exemplary embodiment, the lower electrode 11 is made to be larger than the semiconductor layer 6.

An upper electrode 7 is formed on the semiconductor layer 6. A material having high light-transmittance such as, for example, ITO or IZO (indium zinc oxide) or the like, is used for the upper electrode 7.

In the present exemplary embodiment, the PIN photodiode, that is structured by the lower electrode 11, the semiconductor layer 6 and the upper electrode 7, corresponds to the sensor portion 29.

A protective insulating film 17 is formed on the interlayer insulating film 12 and the upper electrode 7. The protective insulating film 17 is formed from, for example, SiN_{X} or the like. The protective insulating film 17 is formed by, for example, CVD. A contact portion 27, that is for connecting the common electrode line 35 and the upper electrode 7, is provided at the protective insulating film 17.

The common electrode line 35 is formed, on the protective insulating film 17, of Al or Cu, or of an alloy or a layered film formed mainly of Al or Cu.

A contact hole 27A, that is formed in the protective insulating film 17, is provided at the center of the contact portion 27. Further, a contact pad 27B is provided at the contact portion 27 so as to cover the contact hole 27A.

The common electrode line 35 is electrically connected to the upper electrode 7 via the contact portion 27 that is provided at the protective insulating film 17. A bias power source (not shown) is connected to the common electrode line 35. Bias voltage of around several tens of V is supplied from the bias power source.

Scintillators 30, 31 are affixed to one surface side and another surface side of the substrate 1 of the X-ray detecting element 10, by using an adhesive resin 40 having low light absorbance, or the like. The scintillators 30, 31 are formed of GOS. In the present exemplary embodiment, the scintillator 30 corresponds to the wavelength converting portion 24, and the scintillator 31 corresponds to the wavelength converting portion 28.

The operation of the radiation image photographing device 100 relating to the present exemplary embodiment will be described next.

At the radiation image photographing device 100, when a radiation image is photographed, X-rays that have passed through a subject are irradiated onto the X-ray detecting element 10. A high energy component and a low energy component are included in the X-rays that have passed through the subject.

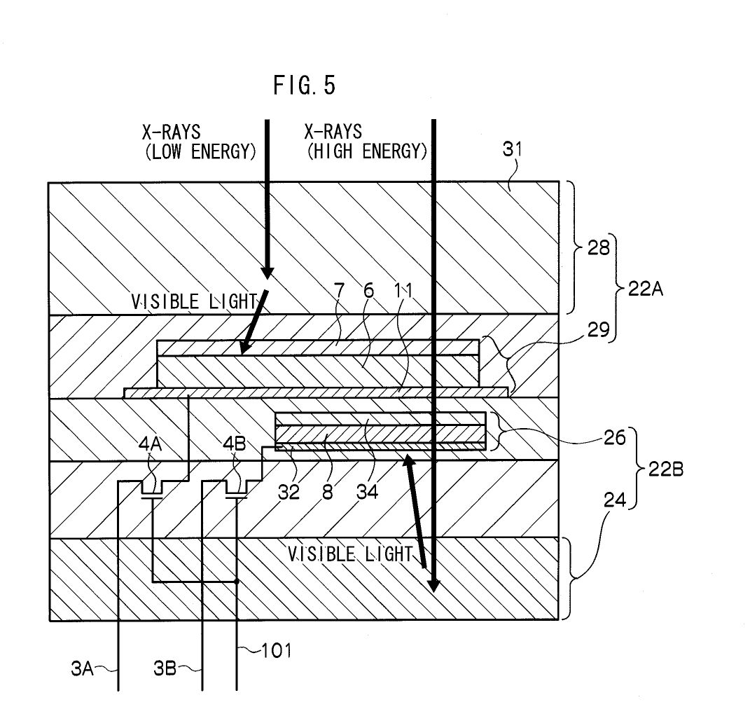

As shown in FIG. 5, the X-ray detecting sections 22A, 22B are layered at each of the pixels 20. Therefore, the low energy X-rays are absorbed at the X-ray detecting section 22A and do not reach the X-ray detecting section 22B. On the other hand, the high energy X-rays pass through the X-ray detecting section 22A and reach the X-ray detecting section 22B. Accordingly, the X-ray detecting section 22A is sensitive to low energy X-rays, and the X-ray detecting section 22B is sensitive to high energy X-rays.

At the X-ray detecting section 22A, the X-rays are converted into visible light at the scintillator 31. Then, the X-ray detecting section 22A generates charges due to the converted visible light being illuminated onto the semiconductor layer 6. Further, at the X-ray detecting section 22B, the X-rays are converted into visible light at the scintillator 30. Then, the X-ray detecting section 22B generates charges due to the converted visible light being illuminated onto the semiconductor layer 8. Even if scintillators of the same material are used as the scintillators 31, 30, low energy X-rays are absorbed at the scintillator 31. Therefore, the scintillator 30 can convert high energy X-rays. Further, the scintillators 30, 31 may be made to be the same thickness. However, it is preferable that the scintillator, that is made to be sensitive to the low energy X-rays, be made to be thinner than the scintillator that is made to be sensitive to the high energy X-rays. In the present exemplary embodiment, the film thickness of the scintillator 31 is made to be 100 μm, and the film thickness of the scintillator 30 is made to be 300 μm.

Further, the X-ray detecting section 22A photographs the low energy radiation image. Therefore, it is preferable that the base material of the scintillator 31 of the X-ray detecting section 22A be structured of a element whose X-ray absorption rate μ does not have a K absorbing end at the high energy portion (i.e., the absorption rate μ does not increase discontinuously at the high energy portion). On the other hand, the X-ray detecting section 22B photographs the high energy radiation image. An ideal combination of materials of the scintillators 31, 30 is materials such that the X-ray absorption rate μ at the high energy portion of the scintillator 30 is higher than that of the scintillator 31. Examples of the combination of the scintillator 30—the scintillator 31 are Y202S:Tb—Gd202s:Tb (GOS), CsI:Tl—Lu202S:Tb, and the like. However, the radiation image photographing device 100 can obtain radiation images by X-rays having different energies by using other materials, provided that the combination thereof satisfies the above-described concept.

At the time of reading-out the image, on signals are successively applied to the gate electrodes 2A, 2B of the TFT switches 4A, 4B via the scan lines 101. Due thereto, the TFT switches 4A, 4B are successively turned on. The charges generated at the X-ray detecting sections 22A flow to the signal lines 3A as electric signals. Further, the charges generated at the X-ray detecting sections 22B flow to the signal lines 3B as electric signals.

On the basis of the electric signals that flow-out to the respective signal lines 3A, 3B, the signal detecting circuit 105 detects the charge amounts, that are generated at the X-ray detecting sections 22A and the X-ray detecting sections 22B, as information of the respective pixels structuring the image. The signal processing device 106 divides the information of the respective pixels detected at the signal detecting circuit 105, into image information from the signal lines 3A and image information from the signal lines 3B, and carries out predetermined processing thereon. In this way, the radiation image photographing device 100 relating to the present exemplary embodiment can obtain image information that expresses the radiation image expressed by the high energy X-rays irradiated on the X-ray detecting element 10, and image information that expresses the radiation image expressed by the low energy X-rays.

Further, the radiation image photographing device 100 relating to the present exemplary embodiment can obtain an energy subtraction image by carrying out subtraction image processing by using the obtained image information expressed by the high energy X-rays and image information expressed by the low energy X-rays.

As described above, the radiation image photographing device 100 relating to the present exemplary embodiment has the scintillator 31 at the outer side (i.e., the side far from the substrate 1) of the sensor portion 26 and the sensor portion 29 of one surface side of the substrate 1. Further, the radiation image photographing device 100 relating to the present exemplary embodiment has the scintillator 30 at the other surface side of the substrate 1. Due thereto, the radiation image photographing device 100 relating to the present exemplary embodiment converts the X-rays, that are irradiated from the one surface side or the other surface side of the substrate 1, into light at the scintillators 30, 31. Then, at the radiation image photographing device 100 relating to the present exemplary embodiment, at each of the pixels 20, the sensor portion 29 detects the light illuminated from the scintillator 31 of the one surface side, and the sensor portion 26 detects the light illuminated from the scintillator 30 of the other surface side of the substrate 1. Accordingly, the radiation image photographing device 100 relating to the present exemplary embodiment can obtain radiation images of two types of energy by the irradiation of X-rays a single time, without positional offset arising between the pixels of the radiation image expressed by the high energy X-rays and the radiation image expressed by the low energy X-rays that are obtained by the X-ray detecting element 10.

Further, the radiation image photographing device 100 relating to the present exemplary embodiment can be structured by a single X-ray detecting element, as compared with being structured by superposing two X-ray detecting elements as is in the conventional case. Therefore, an increase in costs at the time of manufacturing the radiation image photographing device 100 relating to the present exemplary embodiment can be suppressed.

Further, at the radiation image photographing device 100 relating to the present exemplary embodiment, the sensor portion 26 is made to be an MIS photodiode. Moreover, in the radiation image photographing device 100 relating to the present exemplary embodiment, the semiconductor active layer of the TFT switches 4A, 4B and the semiconductor layer of the sensor portion 26, are structured at the same layer by the semiconductor layer 8. Further, the insulating layer of the TFT switches 4A, 4B and the insulating layer of the sensor portion 26, are structured at the same layer by the insulating film 15. Accordingly, at the radiation image photographing device 100 relating to the present exemplary embodiment, an increase in costs at the time of manufacturing the X-ray detecting element 10 is suppressed.

### Second Exemplary Embodiment

Because the structure of the radiation image photographing device 100 relating to a second exemplary embodiment is the same as that of the above-described first exemplary embodiment (see FIG. 1), detailed description thereof is omitted hereafter.

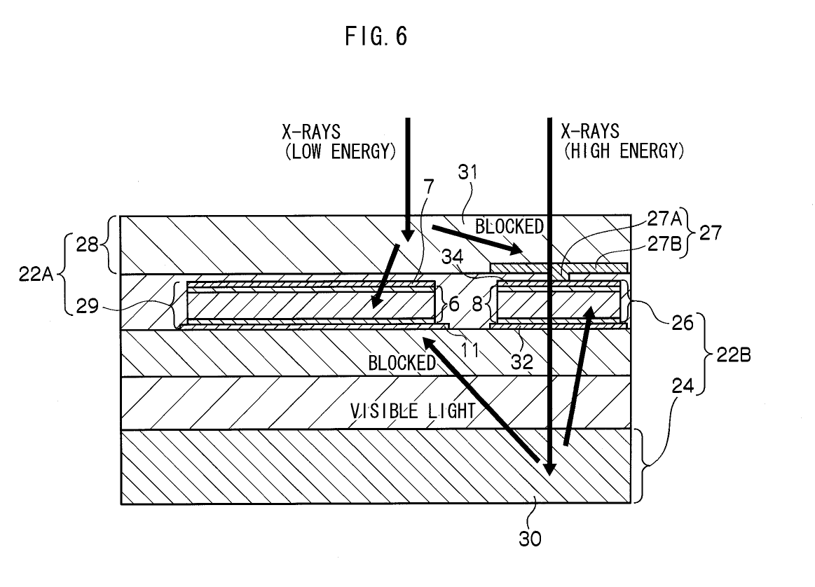

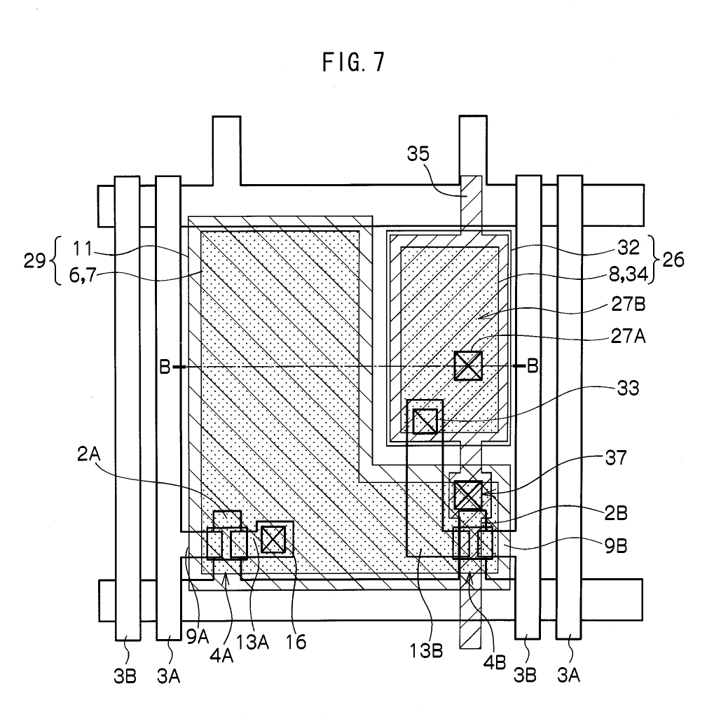

A plan view showing the detailed structure of the pixel 20 of the X-ray detecting element 10 relating to the second exemplary embodiment is shown in FIG. 6. Further, a cross-sectional view along line B-B of FIG. 6 is shown in FIG. 7.

As shown in FIG. 7, at the pixel 20, the sensor portion 26 of the X-ray detecting section 22A and the sensor portion 29 of the X-ray detecting section 22B are provided so as to be lined-up next to one another.

By forming the lower electrode 11 by using a light-blocking metal, light that is illuminated from the other surface side (the substrate 1 side) is blocked. Accordingly, the sensor portion 29 detects light that is illuminated from the one surface side, and generates charges. By forming the contact pad 27B to cover the one surface side of the sensor portion 26, light that is illuminated from the one surface side is blocked. Accordingly, the sensor portion 26 detects light that is illuminated from the other surface side, and generates charges. Note that the blocking of light may be carried out by forming a light-blocking film at each of the other surface side of the sensor portion 29 and the one surface side of the sensor portion 26.

As shown in FIG. 6, at the X-ray detecting element 10, the electrode 32, the semiconductor layer 8 and the electrode 34 that structure the sensor portion 26, and the lower electrode 11, the semiconductor layer 6 and the upper electrode 7 that structure the sensor portion 29, are disposed so as to be lined-up at different regions of the same layers.

The electrode 32 of the sensor portion 26 is connected to the drain electrode 13B of the TFT switch 4B via the contact hole 33 (see FIG. 7). Further, the lower electrode 11 of the sensor portion 29 is connected to the drain electrode 13A of the TFT switch 4A via the contact hole 16.

The electrode 34 of the sensor portion 26 is connected to the common electrode line 35 via the contact portion 27. The upper electrode 7 of the sensor portion 29 is connected to the common electrode line 35 via a contact portion 37.

In this way, at the X-ray detecting element 10 relating to the second exemplary embodiment, at each of the pixels 20, the sensor portion 26 and the sensor portion 29 are provided to be lined-up at separate regions. On the other hand, the scintillators 30, 31 are layered at the both surfaces of each of the pixels 20. The X-rays that have passed through the subject are converted into light at the scintillator 31. On the other hand, high energy X-rays pass through the scintillator 31 and reach the scintillator 30, and are converted into light.

The sensor portion 29 detects the light illuminated from the scintillator 31, and generates charges. The sensor portion 26 detects the light illuminated from the scintillator 30, and generates charges.

Accordingly, the X-ray detecting section 22A, that is structured by the sensor portion 26 and the scintillator 31, is sensitive to low energy X-rays. On the other hand, the X-ray detecting section 22B, that is structured by the sensor portion 29 and the scintillator 30, is sensitive to high energy X-rays.

As described above, in accordance with the second exemplary embodiment, because the sensor portion 26 and the sensor portion 29 are made to be the same layer, an increase in costs at the time of manufacturing the X-ray detecting element 10 can be suppressed. Further, in the X-ray detecting element 10 relating to the second exemplary embodiment, the sensor portion 29 detects light that is illuminated from the scintillator 31 of the one surface side, and the sensor portion 26 detects light that is illuminated from the scintillator 30 of the other surface side of the substrate 1. Accordingly, at the X-ray detecting element 10 relating to the second exemplary embodiment, radiation images of two types of energy can be obtained by the irradiation of X-rays a single time, without positional offset arising between the pixels of the radiation image expressed by the high energy X-rays and the radiation image expressed by the low energy X-rays that are obtained by the X-ray detecting element 10.

Note that, in the above-described first exemplary embodiment, a filter that absorbs low energy X-rays may be formed between the semiconductor layer 6 and the semiconductor layer 8 (e.g., on the interlayer insulating film 12). In a case in which the X-ray detecting section 22A is formed so as to cover the X-ray detecting section 22B as in the first exemplary embodiment, the low energy X-rays are absorbed by the X-ray detecting section 22A. Accordingly, the X-ray detecting section 22A also functions as a filter that absorbs low energy X-rays. However, it is preferable that there be a filter that absorbs low energy X-rays also at the X-ray detecting section 22A side of the X-ray detecting section 22B.

Further, the first exemplary embodiment describes a case in which the sensor portion 26 is an MIS photodiode. However, the present invention is not limited to the same. For example, the sensor portion 26 may be a PIN photodiode. Further, the sensor portion 29 may be an MIS photodiode.

Examples of photodiodes that can be formed on an insulating substrate that is formed from alkaline-free glass or the like as in the present exemplary embodiment include:
(1) PIN: P+, amorphous silicon (the I of Intrinsic), and N+ in that order from the lower layer (VDD>0)
(2) NIP: N+, amorphous silicon (the I of Intrinsic), and P+ in that order from the lower layer (VDD<0), where P+=(P-type impurity doped amorphous silicon), N+=(N-type impurity doped amorphous silicon)
(3) MIS: a lower electrode (M) is covered by an insulating film (I), and amorphous silicon (S) and N+ are layered on the insulating film, MIS=Metal, Insulator, Semiconductor
(4) a TFT diode: refer to JP-A No. 6-237007 for example.

For example, in a case in which the sensor portion 29 is made to be a PIN photodiode and the sensor portion 26 is made to be an MIS photodiode (the case of the above-described first exemplary embodiment), the sensor portion 26 can be formed in the same layer as the TFT switches 4A, 4B. Further, when carrying out photographing of diagnostic images at the sensor portion 29, the frame rate can be made to be high-speed.

Moreover, for example, in a case in which the sensor portion 29 is made to be an MIS photodiode and the sensor portion 26 also is made to be an MIS photodiode, the sensor portion 26 can be formed in the same layer as the TFT switches 4A, 4B. In this case, because both photodiodes are MIS photodiodes, the peripheral circuits can be used in common.

As another example, in a case in which the sensor portion 29 is made to be a PIN photodiode and the sensor portion 26 also is made to be a PIN photodiode, there is the need to form the photodiodes separately from the TFT switches 4A, 4B. However, such a structure can handle increased speed of the frame rate at the time of continuous photographing.

Still further, for example, in a case in which the sensor portion 29 is made to be a PIN photodiode and the sensor portion 26 is made to be a TFT diode, the TFT diode can be used in common as a TFT for switching and as a photosensor.

The above respective exemplary embodiments describe cases in which, as shown in FIG. 1, one of the scan lines 101 is provided for each row of pixels in the one direction, and the TFT switches 4A, 4B of the respective pixels 20 of the pixel row are connected to the same scan line 101. However, for example, two of the scan lines 101 may be provided for each of the pixel rows in the one direction, and the TFT switch 4A and the TFT switch 4B of each pixel 20 of a pixel row may be connected to the different scan lines 101, and the TFT switch 4A and the TFT switch 4B may be switched separately. Further, in this case, one of the signal lines 3 may be provided for each of the pixel columns in the intersecting direction, and the TFT switch 4A and the TFT switch 4B may be connected to the same signal line 3.

The structure (see FIG. 1) of the radiation image photographing device 100 and the structure (FIG. 2 through FIG. 7) of the X-ray detecting element 10, that are described in the above respective exemplary embodiments, are examples. Accordingly, appropriate changes can, of course, be made thereto within a scope that does not deviate from the gist of the present invention.

What is claimed is:

1. An X-ray detecting element comprising:
a substrate that is light-transmissive;
a first photodiode provided at one surface side of the substrate, detecting light that is illuminated from the one surface side, and generating charges;
a second photodiode provided at the one surface side of the substrate, detecting light that is illuminated from another surface side of the substrate, and generating charges;
a plurality of wavelength converting portions respectively provided at outer sides of the first photodiode and the second photodiode of the one surface side of the substrate, and at the another surface side of the substrate, and generating light when X-rays are irradiated;
a first switching element, provided at the one surface side of the substrate and connected to the first photodiode, for reading-out charges that are generated at the first photodiode; and
a second switching element, provided at the one surface side of the substrate and connected to the second photodiode, for reading-out charges that are generated at the second photodiode.

2. The X-ray detecting element of claim 1, wherein the first photodiode and the second photodiode are layered.

3. The X-ray detecting element of claim 1, wherein:
the first photodiode and the second photodiode are aligned in the same layer; and
the X-ray detecting element further comprises:
a first light-blocking film that blocks light at the another surface side of the first photodiode; and
a second light-blocking film that blocks light at the one surface side of the second photodiode.

4. The X-ray detecting element of claim 1, wherein irradiated sides of the wavelength converting portions, at which X-rays are irradiated, have high sensitivity with respect to low energy X-rays, and non-irradiated sides of the wavelength converting portions have high sensitivity with respect to high energy X-rays.

5. The X-ray detecting element of claim 1, wherein the first switching element and the second switching element are formed in the same layer.

6. The X-ray detecting element of claim 1, wherein the first switching element, the second switching element, and at least one of the first photodiode or the second photodiode are formed in the same layer.

7. The X-ray detecting element of claim 6, wherein
the first switching element and the second switching element are thin-film transistors, and
at least one of the first photodiode or the second photodiode is an MIS photodiode, and a semiconductor layer of the MIS photodiode and semiconductor active layers of the thin-film transistors are formed in the same layer, and an insulating layer of the photodiode and insulating layers of the thin-film transistors are formed in the same layer.

8. The X-ray detecting element of claim 1, wherein X-rays are irradiated from the one surface side of the substrate.

9. The X-ray detecting element of claim 1, wherein
a plurality of pixel portions, that detect X-rays as information of pixels structuring a radiation image, are provided at the substrate in a surface direction, and
a plurality of the first photodiode, the second photodiode, the first switching element, and the second switching element are respectively provided for each of the pixel portions.
